(19) United States
(12) Patent Application Publication
(10) Pub. No.: US 2019/0235442 A1
(43) Pub. Date: Aug. 1, 2019

(54) TIMEBASE REGULATED BY FLUID FLOW

(71) Applicant: Preciflex SA, Neuchatel (CH)

(72) Inventors: Lucien Vouillamoz, Feusisberg (CH); Alain Jaccard, Sainte-Croix (CH); Morten Beyer, Rodkaersbro (DK)

(73) Assignee: Preciflex SA, Neuchatel (CH)

(21) Appl. No.: 16/260,620

(22) Filed: Jan. 29, 2019

(30) Foreign Application Priority Data
Feb. 1, 2018 (DE) 102018001049

(51) Int. Cl. G04B 1/26

(52) U.S. Cl. CPC G04B 1/26; G04C 10/00

(57) ABSTRACT

A cadence system consists of a mainspring powering a pump pumping a liquid through a regulation valve, providing a constant energy discharge of said mainspring, the system optionally being immersed in the liquid.

### CROSS REFERENCE TO RELATED APPLICATIONS

This application claims the benefit of German Application No. 102018001049, filed 1 Feb. 2018, the content of the entirety of which is explicitly incorporated herein by reference and relied upon to define features for which protection may be sought hereby as it is believed that the entirety thereof contributes to solving the technical problem underlying the invention, some features that may be mentioned hereunder being of particular importance.

### COPYRIGHT & LEGAL NOTICE

A portion of the disclosure of this patent document contains material which is subject to copyright protection. The Applicant has no objection to the facsimile reproduction by anyone of the patent document or the patent disclosure as it appears in the Patent and Trademark Office patent file or records, but otherwise reserves all copyright rights whatsoever. Further, no references to third party patents or articles made herein is to be construed as an admission that the present invention is not entitled to antedate such material by virtue of prior invention.

### BACKGROUND OF THE INVENTION

The invention relates to wearable accessories like pocket watches, wristwatches, jewelry or any similar wearable objects containing a mechanical source of energy where such energy must be discharged at a controlled speed.

Traditionally in a clockwork mechanism, the force provided by a mainspring is transmitted through a series of gears to power a balance wheel (a weighted wheel which oscillates back and forth at a constant rate). A device called an escapement releases the watch's gears to move forward a small amount with each swing of the balance wheel, moving the watch's hands forward at a constant rate, thereby measuring time. To obtain an ideally constant transmission of energy and a resulting constant frequency of oscillation of the balance wheel, lubrication is applied on all parts which are in contact, minimizing friction. The stability of such traditional systems is impaired by the movement of the lubricants, which end up progressively ejected by the pressure applied at the friction point. At this stage (where lubrication has been ejected at least to some extent), the transmission is no longer provides a suitable energy discharge and so maintenance is required.

What is needed is a novel and intellectually interesting way of controlling the discharge of a mechanical energy storage without the need for maintenance intervention.

### SUMMARY OF THE INVENTION

A cadence system and method/apparatus is provided which provides means for discharging the mechanical energy stored in a spring at a constant rate, without the need for lubrication maintenance. The cadence system consists of a mainspring powering a pump pumping a liquid through a regulation valve, providing a constant energy discharge of said mainspring, the system optionally being immersed in the liquid.

In an object of the invention, this invention allows a novel an intellectually interesting way of ensuring a stable mechanically powered timebase.

In another object, this invention allows a mechanically powered timebase to function with a permanent lubrication, therefore without any need for maintenance.

In still another object, this invention allows to drive an electricity generator at a constant speed and therefore adjusting the generator speed to its maximum efficiency for an optimized converstion of mechanical energy to electrical energy.

In another object, the invention allows the storage of energy in the mechanical form and deliver it in electrical form without the need for batteries, saving the environmental load and social weight usually linked to the production and disposal of batteries.

### BRIEF DESCRIPTION OF THE DRAWINGS

The attached drawings represent, by way of example, different embodiments of the subject of the invention.

FIG. 1 is a schematic view describing the functioning of a system according to the invention.

Those skilled in the art will appreciate that elements in the Figures are illustrated for simplicity and clarity and have not necessarily been drawn to scale. For example, dimensions may be exaggerated relative to other elements to help improve understanding of the invention and its embodiments. Furthermore, when the terms ‘first’, ‘second’, and the like are used herein, their use is intended for distinguishing between similar elements and not necessarily for describing a sequential or chronological order. Moreover, relative terms like ‘front’, ‘back’, ‘top’ and ‘bottom’, and the like in the Description and/or in the claims are not necessarily used for describing exclusive relative position. Those skilled in the art will therefore understand that such terms may be interchangeable with other terms, and that the embodiments described herein are capable of operating in other orientations than those explicitly illustrated or otherwise described.

### DETAILED DESCRIPTION OF THE PREFERRED EMBODIMENT

The following description is not intended to limit the scope of the invention in any way as it is exemplary in nature, serving to describe the best mode of the invention known to the inventors as of the filing date hereof. Consequently, changes may be made in the arrangement and/or function of any of the elements described in the exemplary embodiments disclosed herein without departing from the spirit and scope of the invention.

The system according to this invention operates in one embodiment as a traditional sprinkler system does. It is known to interrupt the flow of liquid from a nozzle free to rotate on an axes by an interruptor which disperses the liquid while providing an impulse to move the nozzle incrementally around the axes. The invention, in one embodiment, provides such a system preferably immersed in a lubricating liquid which is, at the same time, the working liquid ejected by the nozzle. This principal may advantageously be used to drive a timepiece or any other time-related functionality in a wearable device, such as countdown, chronometer, and the like. The driving of an electricity generator (for example a dynamo) allows the powering of functionalities like lighting, any other electrically powered animation or sound, electronic functionality such as communicating a code for identification, for payment and similar applications.

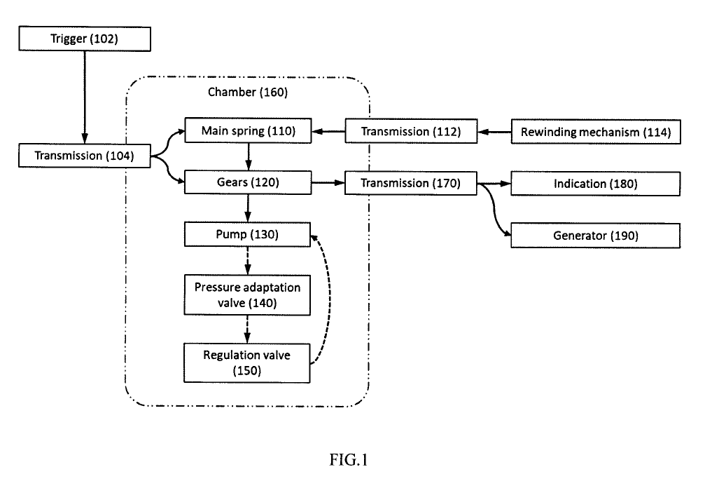

Referring now to FIG. 1, the system according to this invention includes a chamber (160) containing a liquid, said chamber (160) may be transparent to allow visibility of the inside mechanism, the liquid being transparent and/or colored.

The liquid may be selected to have lubricating properties and to contain a limited quantity of dissolved gas so as to prevent the formation of gas bubbles in the liquid during the system's operation over the system's temperature and pressure working ranges. Typically, the liquid has a fusion/freezing point below −20° C. and a boiling point of above +80° C. If the liquid is colored, the colorant is advantageously selected to be of large molecule size, chemically stable in the applicable temperature range and resistant to UV radiation for the life expectancy of the system. The colorant may be e.g. a type of organic die, quantum dots, inorganic die, or pigments, among other things.

The chamber (160) in the present invention may be made of metal, ceramic, polymer, or glass, and in particular sapphire glass. The chamber may be etched in and constructed of plates, may be refined by a further etching step, a layer deposition and structuration step, or a hot embossing step. The substrate used to make the chamber (160) may be made of metal, polymers, or glass, and in particular sapphire glass and be substantially transparent at least in the viewing direction of a user viewing the chamber. The substrate can be of rectangular, circular, circular with an opening (e.g. a hole) in the inner area (e.g. in the center), or any other suitable geometry. A fluid-phobic coating can be applied to the surface in contact with the fluid to improve the liquid's behaviour and/or to improve the chamber's tightness. Further, the coating is selected to be chemically stable in the disclosed temperature range. It may be advantageous to apply a structure to the coating. The coating may be deposited by chemical vapour deposition (CVD), molecular vapor deposition (MVD), dipping, flushing, spin coating, or spraying. The deposited coating may be of constant thickness, homogenous, substantially transparent, and conformal. Suitable materials include fluoropolymers, silane with fluoropolymers, or alcanic chains. The coating can optionally be cured, e.g. by a thermal cure or a ultraviolet cure (UV cure).

The assembling of the invention may include the following assembling operations. In a first step, the chamber is diced into substrate plates by means of a laser, a waterjet, SACE, or sewing. In a second step, the plates are assembled by means of laser welding, anodic bonding, fusion bonding, gluing, or ultrasonic welding. The assembling of the plates requires good adhesion between the plates, low shrinkage, chemical stability, integrity of the sub-layers, in order that swelling is avoided, tightness is ensured, and gas bubbles are avoided. The chamber, formed by the assembled plates, is primed by means of applied vacuum and liquid injection. During the filling of the liquid, the assembled plates must be orientated such that gas bubbles are avoided completely. After filling, a sealing step is applied. An opening may be sealed by gluing, laser welding, or by insertion of a screw and/or a polymer seal and/or a press fit. In addition, during sealing, gas bubbles must be avoided completely.

Materials used for the realization of the present invention are chosen to be suitable and in compliance to the operating temperature range of the invention. Such materials are e.g. metals, polymers or glass, and in particular sapphire glass. In addition, structures used for the realization of the present invention, such as e.g. bellows, chips, or intrinsic membranes, are configured to be suitable and in compliance to the operating temperature range of the invention.

The chamber (160) may include a thermal compensation system, the system comprising a mechanism accommodating thermal expansion and/or contraction of the liquid, avoiding the generation of unacceptably high pressure which could result in liquid leaking out of the system in the event of temperature or pressure rise, or the generation of gas bubbles in the liquid in case of low temperature or low pressure. Such thermal compensation may be made partially or completely invisible to the wearer. Such systems are disclosed in PCT Application No. PCT/IB2015/000448 of the same applicant, entitled SYSTEMS AND METHODS FOR ABSORPTION/EXPANSION/CONTRACTION/MOVEMENT OF A LIQUID IN A TRANSPARENT CAVITY, filed on the 7 Apr. 2015, the contents of which are incorporated herein by reference thereto and relied upon.

The chamber contains the main spring (110), gears (120), a pump (130), a regulation valve (150) and optionally a pressure adaptation valve (140) preferably immersed in the liquid.

The main spring (110), which may be embodied as a spring barrel of a type well known in the horology industry, stores and delivers the mechanical energy to the system. The main spring (110) may be rewound by a rewinding mechanism (114) actuated manually by the user or automatically by a moving mass activated by the movements of the system as it is worn by the user. A transmission (112) allows the passage of the mechanical movement from the rewinding mechanism (114) to the main spring (110) through the wall of the chamber (160) without allowing the liquid to leak. Such transmission may be made via a magnetic coupling or any other appropriate means.

Actuation of the system may be permanent or may be triggered by the user. In such case the user may actuate the trigger (102), the movement of the trigger (102) may be transmitted to release the movement of the main spring (110) or to release the movement of the gears (120) via a transmission (104) passing through the wall of the chamber (160), sealed against leakage. Such a transmission may be activated indirectly via a magnetic coupling or any other appropriate means that avoids the integrity of the chamber to be compromised.

The mechanical energy released by the main spring (110) is transmitted to the pump (130) via gears (120). The dimensioning of the gears (120) takes into account the relative rotation speeds of the spring barrel and of the pump (130). The pump (130) may be a gear pump, or any other pump as well known in the hydraulic industry. The pump (130) sucks the liquid from the chamber (160) and circulates it through an optional pressure adaptation valve (140) and through a regulation valve (150). At the outlet of the regulation valve (150) the liquid is released into the chamber and can be recirculated endlessly.

The regulation valve (150) may be realized in the form of a needle valve, well known in the hydraulic industry, and may have compensation systems to accommodate for the variation of the liquid's viscosity and volumic mass as a function of temperature and/or pressure, so that the liquid flow through the regulation valve (150) and therefore the related mechanical energy discharged from the main spring (110) is substantially constant within the system's operating temperature and pressure ranges.

The gears (120) may be visible within the chamber (160) and may display time-related indication or animation while the system is functioning, and/or may provide mechanical energy to the outside of the chamber (160) via a liquid-tight transmission (170). The mechanical energy provided via the transmission (170) may be used to move an indication (180) of time-related information and/or an animation and/or to drive an electricity generator (190) to power an electric power consuming element. Such generator (190) is disclosed in PCT Application No. PCT/IB2016/000249 of the same applicant, entitled MINIATURE USER-POWERED LIGHTING DEVICE, SYSTEM AND METHOD OF USING SAME, filed on the 7 Mar. 2016, the contents of which are incorporated herein by reference thereto and relied upon.

In a more integrated way, the generator (170) may be split between the rotating part located inside of the chamber (160) and the fixed parts located outside of the chamber (160), avoiding the need for the transmission (170). In such case, the gears (120) may directly drive one or more rotating permanent magnets or magnetized elements, and the resulting varying magnetic field may be captured by coils and optionally a magnetic field concentrator such as a ferromagnetic structure located outside of the chamber (160) to generate electricity.

A further integration step may be done by building the whole generator (190) inside of the chamber (160), in such case only the 2 electrical wires out of the generator need to be connected through the chamber's walls.

It should be appreciated that the particular implementations shown and herein described are representative of the invention and its best mode and are not intended to limit the scope of the present invention in any way.

In an advantage, this invention allows a novel an intellectually interesting way of ensuring a stable mechanically powered timebase.

In a further advantage, this invention allows a mechanically powered timebase to function with a permanent lubrication, therefore without any need for maintenance.

In a further advantage, this invention allows to drive an electricity generator at a constant speed and therefore adjusting the generator speed to its maximum efficiency for an optimized converstion of mechanical energy to electrical energy.

In a further advantage this invention allows to store energy in the mechanical form and deliver it in electrical form without the need for batteries, saving the environmental load and social weight usually linked to the production and disposal of batteries.

As will be appreciated by skilled artisans, the present invention may be embodied as a system, a device, or a method.

Moreover, the system contemplates the use, sale and/or distribution of any goods, services or information having similar functionality described herein.

The specification and figures should be considered in an illustrative manner, rather than a restrictive manner, and all modifications described herein are intended to be included within the scope of the invention claimed. Accordingly, the scope of the invention should be determined by the appended claims (as they currently exist or as later amended or added, and their legal equivalents) rather than by merely the examples described above. Steps recited in any method or process claims, unless otherwise expressly stated, may be executed in any order and are not limited to the specific order presented in any claim. Further, the elements and/or components recited in apparatus claims may be assembled or otherwise functionally configured in a variety of permutations to produce substantially the same result as the present invention. Consequently, the invention should not be interpreted as being limited to the specific configuration recited in the claims.

Benefits, other advantages and solutions mentioned herein are not to be construed as critical, required or essential features or components of any or all the claims.

As used herein, the terms “comprises”, “comprising”, or variations thereof, are intended to refer to a non-exclusive listing of elements, such that any apparatus, process, method, article, or composition of the invention that comprises a list of elements, that does not include only those elements recited, but may also include other elements such as those described in the instant specification. Unless otherwise explicitly stated, the use of the term “consisting” or “consisting of” or “consisting essentially of” is not intended to limit the scope of the invention to the enumerated elements named thereafter, unless otherwise indicated. Other combinations and/or modifications of the above-described elements, materials or structures used in the practice of the present invention may be varied or adapted by the skilled artisan to other designs without departing from the general principles of the invention.

The patents and articles mentioned above are hereby incorporated by reference herein, unless otherwise noted, to the extent that the same are not inconsistent with this disclosure.

The invention can be summarized by the following feature sets.
1. A cadence system consisting of a mainspring powering a pump pumping said liquid through a regulation valve, providing a constant energy discharge of said mainspring, the system optionally being immersed in a lubricating liquid.
2. A method consisting of animating an object, such as personal accessories, using the system of feature set 1.

Other characteristics and modes of execution of the invention are described in the appended claims.

Materials used for the realization of the present invention are chosen to be suitable and in compliance to the operating temperature range of the invention. Such materials are e.g. metals, polymers or glass, and in particular sapphire glass. Equally for structures used for the realization of the present invention, such structures, as e.g. bellows, chips, or intrinsic membranes, are configured to be suitable and in compliance to the operating temperature range of the invention.

Further, the invention should be considered as comprising all possible combinations of every feature described in the instant specification, appended claims, and/or drawing figures that may be considered new, inventive and industrially applicable.

Copyright may be owned by the Applicant(s) or their assignee and, with respect to express Licensees to third parties of the rights defined in one or more claims herein, no implied license is granted herein to use the invention as defined in the remaining claims. Further, vis-à-vis the public or third parties, no express or implied license is granted to prepare derivative works based on this patent specification, inclusive of the appendix hereto and any computer program comprised therein.

Additional features and functionality of the invention are described in the claims appended hereto and/or in the abstract. Such claims and/or abstract are hereby incorporated in their entirety by reference thereto in this specification and should be considered as part of the application as filed.

Multiple variations and modifications are possible in the embodiments of the invention described here. Although certain illustrative embodiments of the invention have been shown and described here, a wide range of changes, modifications, and substitutions is contemplated in the foregoing disclosure. While the above description contains many specific details, these should not be construed as limitations on the scope of the invention, but rather exemplify one or another preferred embodiment thereof. In some instances, some features of the present invention may be employed without a corresponding use of the other features. Accordingly, it is appropriate that the foregoing description be construed broadly and understood as being illustrative only, the spirit and scope of the invention being limited only by the claims that ultimately issue in this application.

What is claimed is:

1. A cadence system consisting of a mainspring powering a pump pumping said liquid through a regulation valve, providing a constant energy discharge of said mainspring, the system optionally being immersed in a lubricating liquid.

2. A method consisting of animating an object, such as personal accessories, using the system of claim 1.

3. The system(s) and/or method(s) as described in the instant specification, dependent claims, abstract (herein incorporated by reference), and/or drawing figures.
